(19) United States
(12) Patent Application Publication
(10) Pub. No.: US 2002/0051638 A1
(43) Pub. Date: May 2, 2002

(54) Camera and printing apparatus

(76) Inventor: Kazuhiko Arakawa, Kanagawa (JP)

Correspondence Address: ROBIN BLECKER & DALEY, 2ND FLOOR, 330 MADISON AVENUE, NEW YORK, NY, 10017, US

(21) Appl. No.: 09/902,020

(22) Filed: Jul. 10, 2001

(30) Foreign Application Priority Data
Jul. 19, 2000 (JP) 2000-219123

(51) Int. Cl. G03B 17/24

(52) U.S. Cl. 396/311; 396/319

(57) ABSTRACT

A camera and a printing apparatus are provided, which are able to produce a high-quality photographic print with the optimum density for a human subject within a short period of time. When a human subject taking switch 14 is turned on to receive an instruction for the camera user to take a human subject photograph, that is, when an instruction for a camera user to take a human subject photograph is inputted, a magnetic recording circuit 28 controls the magnetic head so as to write, in synchronism with winding of the film, information indicative of human subject photography, i.e. the subject is one or more persons (human subject information) and other information (photographic information, date and time information, and the like) in a magnetic information-recording section 21 on the film.

### BACKGROUND OF THE INVENTION

1. Field of the Invention

The present invention relates to a camera that records photographic information on human subject photography and a printing apparatus that reflects the photographic information in photographic prints.

2. Description of Related Art

Conventionally, an image that is exposed on a film by a photographic camera is developed and finished as a photographic print by a printing apparatus.

Ordinarily, professionals at laboratories, not camera users, carry out the printing operation. At the laboratories, a print density that is considered to be suitable in view of information such as a film density is determined prior to the printing operation. Since people other than the camera users carry out the printing operation, however, the finished prints may have different densities from what is expected by the camera users and may displease them.

Particularly, if a main subject is a person, it is necessary to be attentive to the printing operation since a photographic print in which the subject is partially dark or white displeases a camera user in many cases. It is therefore important to determine what the main subject is and whether the main subject is a person in the printing operation. Accordingly, a method has been proposed which comprises extracting a person on a film with reference to image information and main subject information on the film and adjusting the print density so that the extracted person can be printed with the optimum density (Japanese Laid-Open Patent Publication (Kokai) No. 5-127270).

A camera has also been proposed which recognizes the position of a main subject and records information on the recognized position (Japanese Laid-Open Patent Publication (Kokai) No. 5-158132).

Another camera has been proposed which estimates that a main subject is a person and selects distance measurement data from information on the estimation result (Japanese Laid-Open Patent Publication (Kokai) No. 8-054558).

It is, however, necessary to carry out vast amounts of operations in reading image information on a film during printing operation and analyzing an image with reference to the image information to extract a person. Therefore, this method is difficult to execute at laboratories that are required to complete a large amount of work within a short period of time.

Further, even if a camera records the position of a main subject on a film and the film is read at laboratories, an image cannot be printed with the optimum density for a human subject since it is impossible to determine whether the main subject is a landscape, a person or an object.

### SUMMARY OF THE INVENTION

It is therefore an object of the present invention to provide a camera and a printing apparatus that are able to produce a high-quality photographic print with the optimum density for a human subject within a short period of time.

To attain the above object, a first aspect of the present invention provides a camera comprising an input device for inputting an instruction for a camera user to take a human subject photograph, and a recording device responsive to inputting of the instruction for the camera user to take the human subject photograph by the input device, for recording information indicative of human subject photography in a manner corresponding to a captured image.

In a preferred embodiment of the first aspect, the input device comprises an operation switch.

In another preferred embodiment, the input device comprises a speech recognition device.

To attain the above object, a second aspect of the present invention provides a camera comprising a determination device for determining a value representing a possibility of human subject photography according to at least one setting condition which is likely to be used for human subject photography, among a plurality of setting conditions relating to a photographing operation, and the recording device for recording the value representing the possibility of human subject photography determined by the determination device, in a manner corresponding to a captured image.

Preferably, the at least one setting condition likely to be used for the human subject photography includes at least one of a red-eye alleviation mode, a portrait mode, a number-of-prints setting, a self-timer mode, and a remote control mode.

To attain the above object, a third aspect of the present invention provides a camera comprising the determination device for determining a value representing a possibility of human subject photography according to a plurality of setting conditions which are likely to be used for human subject photography among a plurality of setting conditions relating to a photographing operation, the recording device for recording the value representing the possibility of human subject photography, determined by the determination device, in a manner corresponding to a captured image, and wherein the determination device determines the value representing the possibility of human subject photography, by accumulating values representing possibilities of human subject photography corresponding respectively to the plurality of setting conditions which are likely to be used for human subject photography.

To attain the above object, a fourth aspect of the present invention provides a camera comprising the determination device for determining a value representing a possibility of human subject photography by recognizing at least one speech or at least one speech similar thereto, and the recording device for recording the value representing the possibility of human subject photography determined by the determination device, in a manner corresponding to a captured image. in a preferred embodiment of the first second and fourth aspects, the recording device magnetically records the information on a film.

Alternatively, the recording device records the information in an external memory.

In a preferred embodiment of the first to fourth aspects, the camera further comprises a calculating device for calculating a subject image magnification, and if the subject image magnification calculated by the calculating device lies in a predetermined range, the recording device records the information indicative of human subject photography in a manner corresponding to the captured image.

More preferably, the predetermined range of the subject image magnification is substantially between 1/150 and 1/25 in terms of 135 film magnification if a human subject is photographed.

To attain the above object, a fifth aspect of the present invention provides a printing apparatus that adjusts a print density according to the information indicative of human subject photography or the value representing the possibility of human subject photography, the information or the value being magnetically recorded on the film by a camera according to any of the first to fourth aspects.

The above and other objects, features and advantages of the invention will become more apparent from the following detailed description taken in conjunction with the accompanying drawings.

### BRIEF DESCRIPTION OF THE DRAWINGS

FIG. 1 is a view showing the front face of a camera according to a first embodiment of the present invention;

FIG. 2 is a view showing the back face of the camera in FIG. 1;

FIG. 3 is a schematic view showing a film for use with the camera in FIG. 1;

FIG. 4 is a block diagram showing the arrangement of electrical circuits in the camera in FIG. 1;

FIG. 5 is a flow chart showing the operation of a microcomputer 22 in FIG. 4;

FIG. 6 is a conceptual diagram showing a process of producing a photographic print;

FIGS. 7A and 7B is a flow chart showing the operation of a microcomputer 22 according to a second embodiment of the present invention;

FIG. 8 is a view showing the front face of a camera according to a third embodiment of the present invention;

FIG. 9 is a block diagram showing the arrangement of electrical circuits in the camera in FIG. 8; and

FIG. 10 is a flow chart showing the operation of a microcomputer 49 in FIG. 9.

### DETAILED DESCRIPTION OF THE PREFERRED EMBODIMENTS

Preferred embodiments of the present invention will hereunder be described with reference to the accompanying drawings.

(First Embodiment)

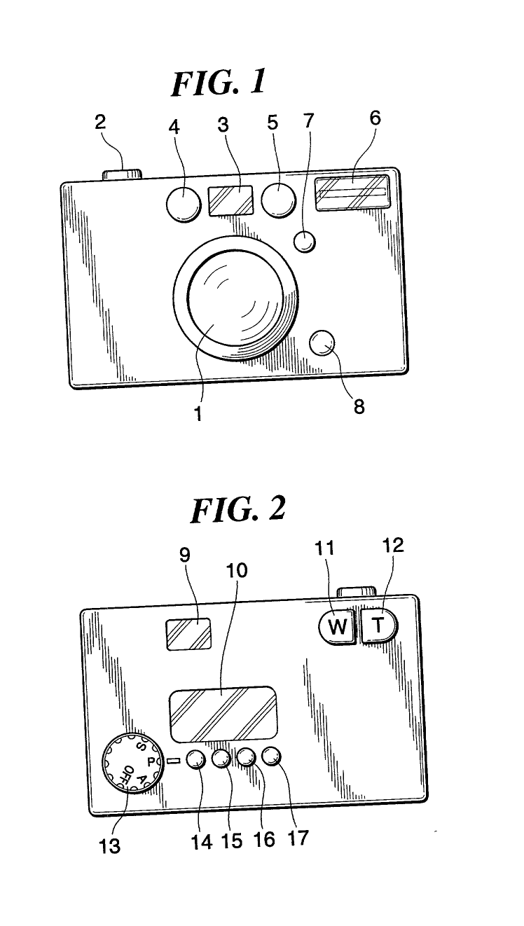

FIG. 1 is a view showing the front face of a camera according to a first embodiment of the present invention.

In FIG. 1, reference numeral 1 denotes a taking lens; 2, a shutter release button; 3, a finder objective window; 4, an AF (auto-focus) infrared-emitting section; 5, an AF light-receiving section; 6, a strobe light-emitting section; 7, a light measuring section; 8, a remote controlled light-receiving section. This structure is substantially the same as the outside structure of an ordinary camera.

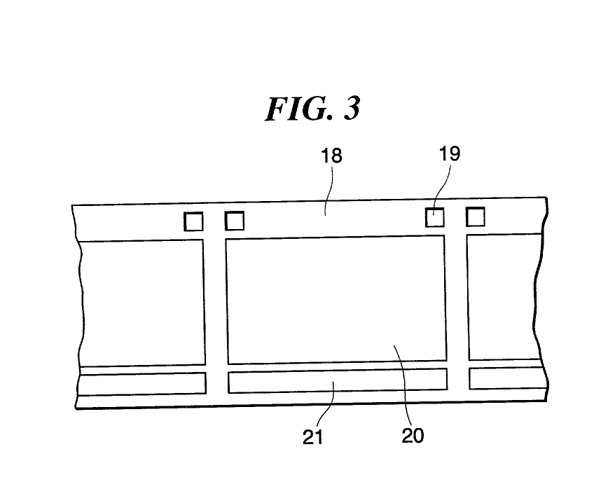

FIG. 2 is a view showing the back face of the camera in FIG. 1.

In FIG. 2, reference numeral 9 denotes a finder eyepiece window, and reference numeral 10 denotes a crystal display that displays the setting conditions of the camera. Reference numerals 11 and 12 denote zoom switches for use in changing the focal length of a lens to a wide-angle side and a telephoto-angle side, respectively. Reference numeral 13 denotes a camera mode dial for use in optimizing the photographing conditions of the camera for a subject. By operating the camera mode dial 13, a camera user selects various photographic setting conditions according to a subject.

Examples of the photographic setting conditions are as follows:

OFF mode: a mode for stopping the operation of the camera or housing the camera;

A (auto) mode: a mode for selecting a standard program for selecting a shutter speed, an aperture value, and the like so as to shoot an ordinary subject;

P (portrait) mode: a mode for selecting a function of automatically changing the focal length according to the distance derived from AF results so that a shooting magnification can be about 1/25-1/30 in order to make a picture composition suitable for a portrait (auto-zooming function), or an exposure controlling function of shading off the background by opening up the lens; and

S (sports) mode: a mode for selecting a high shutter speed so as to shoot a fast-moving subject such as an exercising person and a running vehicle, or selecting a servo mode AF so as to cause an AF mechanism to continuously follow a moving subject.

Reference numeral 14 denotes a human subject taking switch (operation switch) that is operated by a camera user who is taking a human subject photograph. The input of this switch causes the camera to magnetically record information, which indicates that a human subject is to be photographed in a next shot, in an information-recording section on the film, described later. Reference numeral 15 denotes a number-of-prints setting switch. The input of this switch causes the camera to magnetically record information, which indicates a desired number of prints for a subject to be shot next, in the information-recording section on the film.

Reference numeral 16 denotes a self-timer/remote-control mode setting switch. The input of this switch causes the camera to shoot a subject in a next shot in a self timer mode or a remote control mode. Reference numeral 17 denotes a red-eye alleviation mode setting switch. The input of this switch sets the camera to a red-eye alleviation mode. A red-eye effect means that when a person in dark is shot by a strobe, a strobe light reflects on the retinas of the person to make his or her eyes red in a finished photoprint. If the camera is set to the red-eye alleviation mode, a redeye alleviation function of reducing the pupil of a subject is executed by lighting a lamp or emitting a strobe light for a predetermined period of time before strobe light photography.

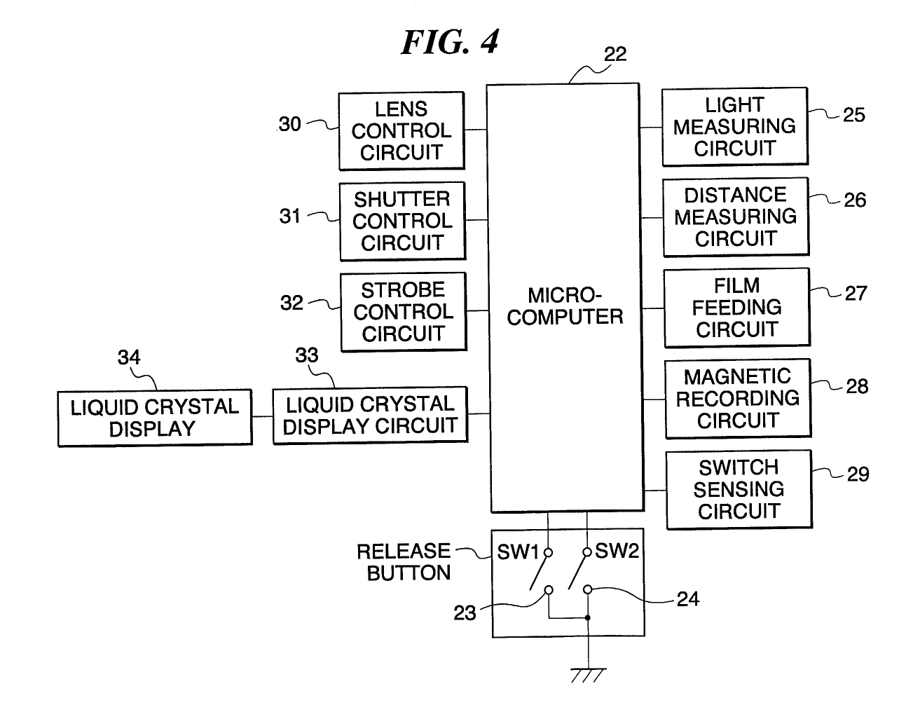

FIG. 3 is a view showing a film for use with the camera in FIG. 1.

In FIG. 3, reference numeral 18 denotes a film whose entire surface is coated with a transparent magnetic recording layer. Reference numeral 19 denotes a perforation for use in finding a feed position of the film, and reference numeral 20 denotes an image exposure surface on which an image is exposed. Reference numeral 21 denotes a magnetic recording section corresponding to the image exposure surface. Various pieces of photographic information on a subject to be photographed in a frame corresponding to the image exposure surface are recorded in the magnetic recording section 21 by a magnetic head, not illustrated.

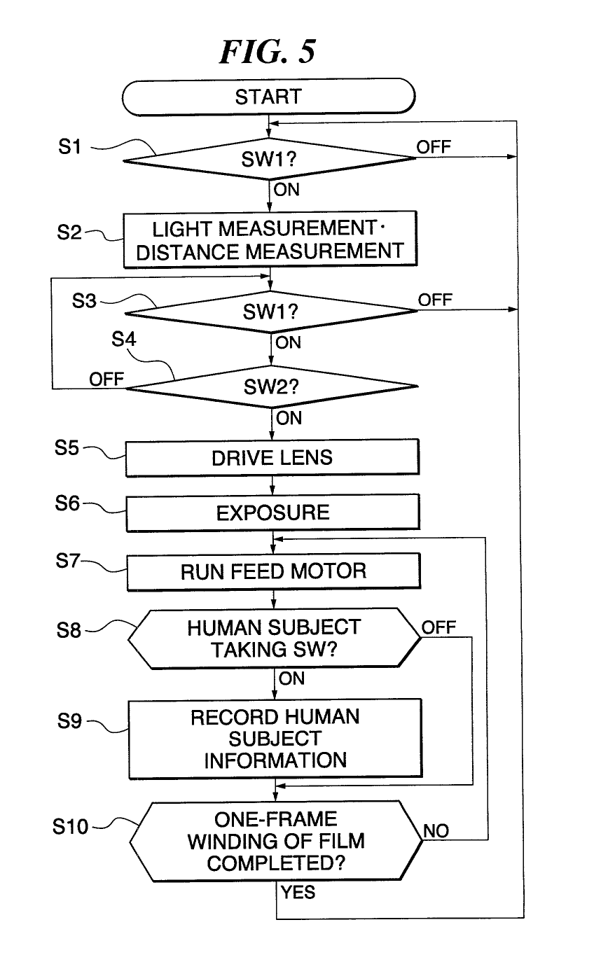

FIG. 4 is a block diagram showing the arrangement of electrical circuits in the camera in FIG. 1.

In FIG. 4, reference numeral 22 denotes a microcomputer that controls the operation of the camera as a whole. Reference numerals 23 and 34 denote switches that operate in association with the shutter release button 2: a switch SW1 is turned on by depressing half the shutter release button 2, and a switch SW2 is turned on by fully depressing the shutter release button 2.

Reference numeral 25 denotes a light measuring circuit that measures the subject brightness, and the measurement result is used for determining an exposure value. Reference numeral 26 denotes a distance measuring circuit that measures the distance to a subject (subject distance), and the measurement result is used for calculating a lens drive amount that is required for focusing. Reference numeral 27 denotes a film feeding circuit that controls the operation of a motor for winding and rewinding the film. Reference numeral 28 denotes a magnetic recording circuit that records photographic information in the magnetic recording section 21 on the film and controls the magnetic head for use in reading the recorded photographic information. Reference numeral 29 denotes a switch sensing circuit that detects the conditions of the camera mode dial 13 and other various setting switches.

Reference numeral 30 denotes a lens control circuit that controls a focusing operation of the lens according to the calculated lens drive amount, and reference numeral 31 denotes a shutter control circuit that opens and closes a shutter according to the exposure value. Reference numeral 32 denotes a strobe control circuit that controls the emission of a strobe light. Reference numeral 33 denotes a liquid crystal display circuit that controls the conditions of various setting switches detected by the switch sensing circuit 29, that is, a screen of a liquid crystal display 34 that displays the conditions or status of setting switches for setting various shooting modes, the number of prints, and others.

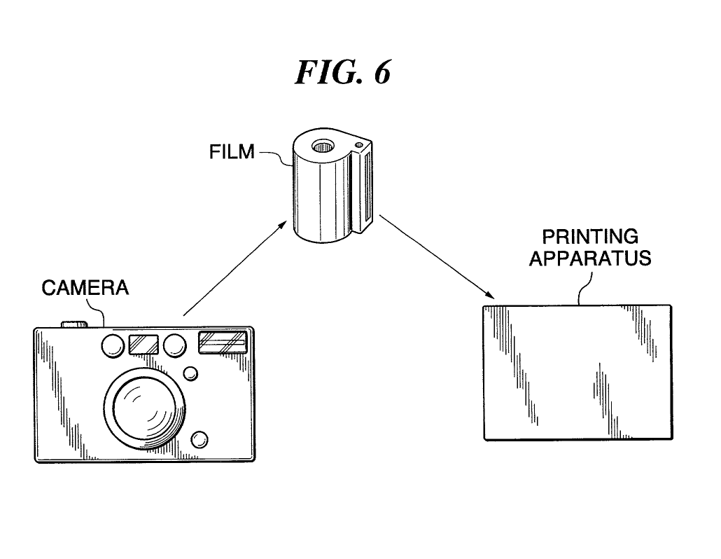

A description will be given of the operation of the microcomputer 22 according to the first embodiment with reference to a flow chart of FIG. 5.

At the start of the operation, the camera mode dial 13 is rotated from an OFF position to another position to turn on a power supply to a camera body. The switch sensing circuit 29 then detects the conditions or status of various control members and switches. If it is then determined in a step Si that the switch SW1 has been turned on by depressing half the shutter release button 2, the process proceeds to a step S2.

In the step S2, information is inputted from the light measuring circuit 25 and the distance measuring circuit 26 so as to find information on the subject brightness and the subject distance. The exposure value is determined according to such information and a known film sensitivity.

In a step S3, the status of the switch SW 1 is detected again. If the switch SW1 is OFF, the process returns to the step S1. If the switch SW1 is still ON, the process proceeds to a step S4 so as to detect the status of the switch SW2. When the shutter release button 2 is fully depressed to turn on the switch SW2, the process proceeds to a step S5. If the switch SW2 is OFF, the process returns to the step S3.

In the step S5, the lens control circuit 30 determines the lens drive amount according to the subject distance information acquired in the step S2, and then drives the lens to a focusing position. If the lens has moved to a predetermined position, the process proceeds to a step S6 wherein the shutter control circuit 31 and the strobe control circuit 32 control the opening and closing actions of the shutter and the emission of the strobe light to expose a subject image on the film.

Upon completion of the exposure, the process proceeds to a step S7 wherein a feed motor rotates under the control of the film feeding circuit 27 to start winding the film.

In a step S8, the status of the human subject taking switch 14 is detected. When the human subject taking switch 14 is ON, that is, when an instruction for a camera user to take a human subject photograph is inputted, the process proceeds to a step S9. In the step S9, the magnetic recording circuit 28 controls the magnetic head so as to write, in synchronism with winding of the film, information indicative of human subject photography, i.e. the subject is one or more persons (human subject information) and other information (photographic information, date and time information, and the like) in the magnetic information-recording section 21 on the film. An example of the human subject information is a mark that enables human subject photography to be recognized when the printing operation is carried out at a laboratory or the like.

After the information is recorded in the magnetic information-recording section 21 on the film, the process proceeds to a step S10. If the human subject taking switch 14 is OFF in the step S8, the process proceeds to the step S10 while skipping the step S9. If it is detected in the step S10 that the film has been wound by one frame, the sequence of operations is finished and the process returns to the start of the operation. If the film has not yet been wound by one frame, the process returns to the step S7.

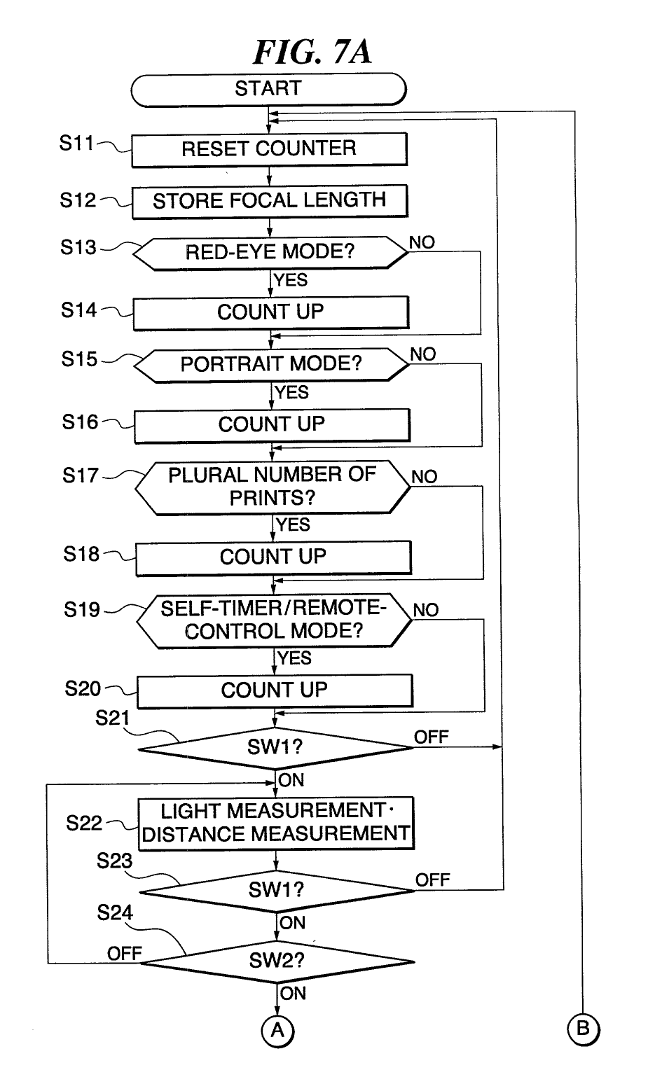

FIG. 6 is a conceptual diagram showing the process of making a photographic print.

An exposed film is printed by a printing apparatus that is placed at a laboratory or the like. If the information indicative of human subject photography is recorded in the magnetic information-recording section 21 on the film, the printing apparatus sets the print density according to this information.

According to the present embodiment, when receiving the instruction for the camera user to take a human subject photograph (turning on the human subject taking switch 14), the camera records the information indicative of human subject photography in association with an exposure frame (captured image) on the film. Therefore, when the image is printed, the printing apparatus can produce a high grade print with the optimum density for the face of a person as the subject according to the information indicative of human subject photography.

Instead of the human subject taking switch 14, a speech recognition circuit may be used to input the instruction for the camera user to take a human subject photograph. Further alternatively, the sight line of a camera user who is looking through the finder may be detected by using a human subject photograph input region provided in the view field of the finder to thereby input the instruction to take a human subject photograph.

(Second Embodiment)

Next, a description will be given of a camera according to a second embodiment of the present invention.

The camera according to this embodiment has the same mechanical structure, circuit arrangement, and the like as those of the camera according to the first embodiment, and thus description thereof is omitted.

The present embodiment is characterized in that the camera is able to determine the possibility that a human subject has been photographed, according to the conditions of various setting modes without receiving an instruction for a camera user to take a human subject photograph. The microcomputer 22 has a counter that counts a value (counter value) representing the possibility of human subject photography.

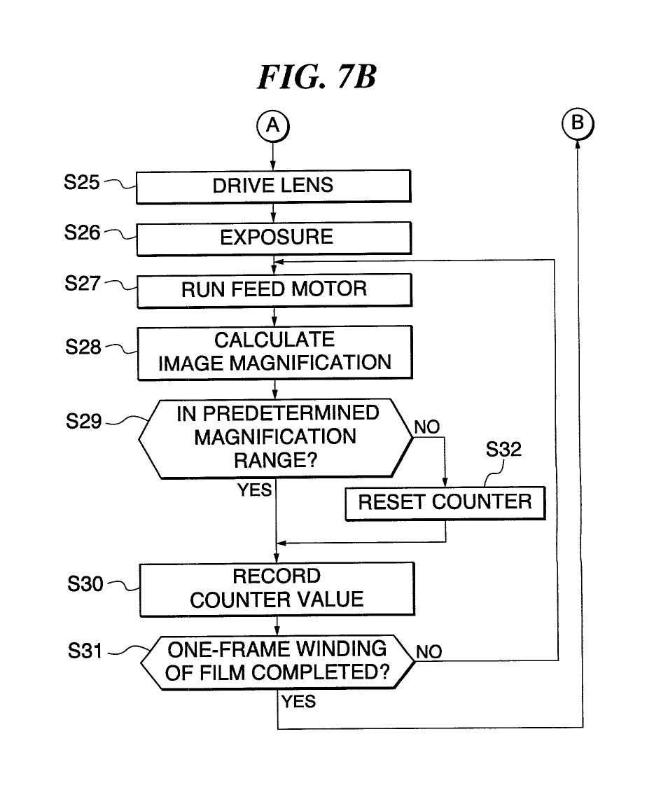

FIG. 7A and 7B is a flow chart showing the operation of the microcomputer 22 according to the present embodiment.

At the start of the operation, the mode dial 13 rotates from an OFF position to another position to turn on the power supply to the camera body. The switch sensing circuit 29 then receives the input of various control members and switches. In a step S11, the counter is reset. The process then proceeds to a step S12 so as to store focal length information transmitted from a lens focal length detector, not shown. The process then proceeds to a step S13.

From the step S13 through a step S19, the switch sensing circuit 29 detects the output of various setting conditions relating to a photographing operation and counts the counter value.

In the step S13, the status of the red-eye alleviation mode setting switch 17 is detected. If the red-eye alleviation mode is set, the process proceeds to a step S14 so as to cause the counter to count forward. If the red-eye alleviation mod is not set, the process proceeds to a step S15 without causing the counter to count forward. When the red-eye alleviation mode is selected, the counter is caused to count forward because there is a high possibility that a human subject will be photographed.

Similarly, the counter is caused to count up at the step S15 through a step S20 when the portrait mode is designated by operating the camera mode dial 13 (the portrait mode is originally set for taking a human subject photograph), when a plural number of prints is designated by operating the number-of-prints setting switch 15 (there is a high possibility that a picture of plural persons will be taken and prints thereof will be handed to the persons), and when the self-timer mode or the remote control mode is designated by operating the self timer mode/remote control mode setting switch 16 (there is a high possibility that a human subject will be photographed as in the case of a commemorative picture).

If it is then detected in the next step S21 that the switch SW1 has been turned on by depressing half the shutter release button 2, the process proceeds to a step S22. In the step S22, information is inputted from the light measuring circuit 25 and the distance measuring circuit 26 to acquire information on the subject brightness and the subject distance. An exposure value is determined according to this information and the film sensitivity.

In the next step S23, the status of the switch SW1 is detected. If the switch SW1 is OFF, the process returns to the step S11. If the switch SW1 is ON, the process proceeds to a step S24 to detect the status of the SW2. When the shutter release button 2 is fully depressed to turn on the switch SW2, the process proceeds to a step S25. If the switch SW2 is OFF, the process returns to the step S22.

In the step S25, the lens control circuit 30 determines a lens drive amount according to the information on the subject distance acquired in the step S22, and then drives the lens to a focusing position. If the lens has moved to a predetermined position, the process proceeds to a step S26. In the step S26, the shutter control circuit 31 and the strobe control circuit 32 control the opening and closing actions of the shutter and the emission of the strobe light, respectively, according to the exposure value determined in the step S22 to expose a subject image on the film.

Upon completion of the exposure, the process proceeds to a step S27 wherein the feed motor rotates under the control of the film feed circuit 27 to start winding the film.

The process then proceeds to a step S28 wherein the image magnification of a subject to be photographed is calculated from the lens focal length stored in the step S12 and the subject distance measured in the step S22. The process then proceeds to a step S29. Specifically, the image magnification of a subject to be photographed is found by dividing the lens focal length stored in the step S12 by the subject distance measured in the step S22. Even if a human subject is photographed, there is no use determining the print density based on the face of the subject when the size of the human subject is too small or too large in the picture. Accordingly, it is determined in the step S29 whether the image magnification lies inside a predetermined range. The predetermined range is substantially between 1/150 and 1/25 in the case of a 135 film, and is substantially between 1/214 and 1/36 in the case of an APS film. In a digital camera with a smaller image screen size, the predetermined range is set to a smaller value range.

If the size of a person or persons lies in a certain meaningful range at the time of printing (that is, the image magnification lies in the predetermined range), the process proceeds to a step S30 to detect the status of the respective switches and magnetically record the counted-up counter value on the film as is the case with the first embodiment. The larger the counter value, the higher the possibility that a human subject has been photographed. At the time of printing, an algorithm for finding the print density may be changed according to the counter value. Instead of the counter value, a mark or the like may be used to indicate the possibility of human subject photography.

If it is detected in a step S31 that the film has been wound by one frame, the sequence of operations is finished and the process returns to the starting point. If the film has not yet been wound by one frame, the proceeds returns to the step S27.

If the image magnification lies outside the predetermined range in the step S29, the process proceeds to a step S32 to reset the counter value. More specifically, even if the counter value indicates a high possibility that a human subject has been photographed, the information indicating a low possibility of human subject photography, i.e. the reset counter value is magnetically recorded on the film when the image magnification lies outside the predetermined range.

According to the present embodiment, the camera gradually determines the possibility of human subject photography according to the setting conditions and the image magnification, which are likely to be used for taking a human subject photograph, i.e. the focal length and the subject distance without receiving an instruction from a camera user who is taking a human subject photograph. The determination result can be recorded on the film.

Moreover, the printing apparatus in FIG. 6 is able to set the print density on the basis of a value, which is recorded on the film to indicate the possibility of human subject photography. This makes it possible to produce a high grade photographic print with the optimum density for a human subject.

In the first embodiment and a later-described third embodiment as well, if the image magnification lies in the predetermined range, the information indicative of human subject photography or the value indicating the possibility of human subject photography may be recorded on the film.

(Third Embodiment)

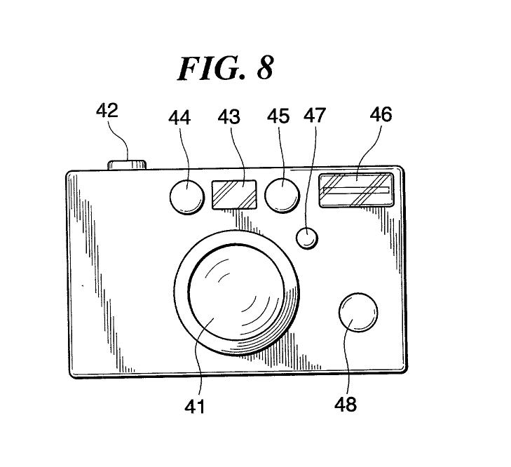

FIG. 8 shows the front face of a camera according to the third embodiment.

In FIG. 8, reference numeral 41 denotes a taking lens; 42, a shutter release button; 43, a finder objective window; 44, an AF infrared-emitting section; 45, an AF light-receiving section; 46, a strobe-emitting section; 47, a light measuring section; and 48, a microphone for recording ambient sounds.

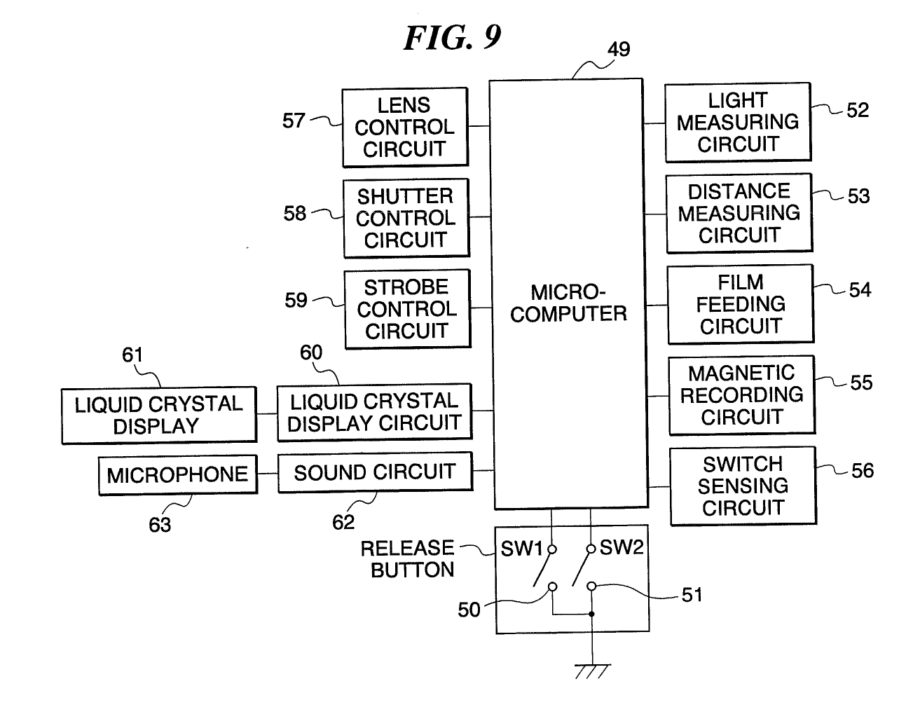

FIG. 9 is a block diagram showing the arrangement of electrical circuits in the camera in FIG. 8.

In FIG. 9, reference numeral 49 denotes a microcomputer that controls the operation of the camera as a whole. Reference numeral 50 and 51 denote switches that operate in association with the shutter release button 42: a switch SW1 is turned on by depressing half the shutter release button 42, and a switch SW2 is turned on by fully depressing the shutter release button 42.

Reference numeral 52 denotes a light measuring circuit, which measures the subject brightness, and the measurement result is used in determining the exposure value. Reference numeral 53 denotes a distance measuring circuit, which measures the distance to the subject, and the measurement result is used in calculating a lens drive amount required for focusing. Reference numeral 54 denotes a film feeding circuit, which controls the operation of a motor for winding and rewinding the film. Reference numeral 55 denotes a magnetic recording circuit, which records photographic information in a magnetic recording section on the film and controls a magnetic head for use in reading the photographic information recorded in the magnetic recording section. Reference numeral 56 denotes a switch sensing circuit, which detects the conditions or status of various setting switches.

Reference numeral 57 denotes a lens control circuit that controls the focusing action of the lens according to the calculated lens drive amount, and reference numeral 58 denotes a shutter control circuit that controls the opening and closing actions of the shutter according to the exposure value. Reference numeral 59 denotes a strobe control circuit that controls the emission of a strobe light. Reference numeral 60 denotes a liquid crystal display circuit that controls the conditions of various setting switches detected by the switch sensing circuit 56, that is, a screen of a liquid crystal display 61 that displays the conditions of setting switches indicating various shooting modes, the number of prints, and the like.

Reference numeral 62 denotes a sound circuit, which is comprised of a microphone control circuit section that controls a microphone 63 for converting the ambient sounds into electric signals, and a speech recognition circuit section that extracts specific words from recorded sound signals.

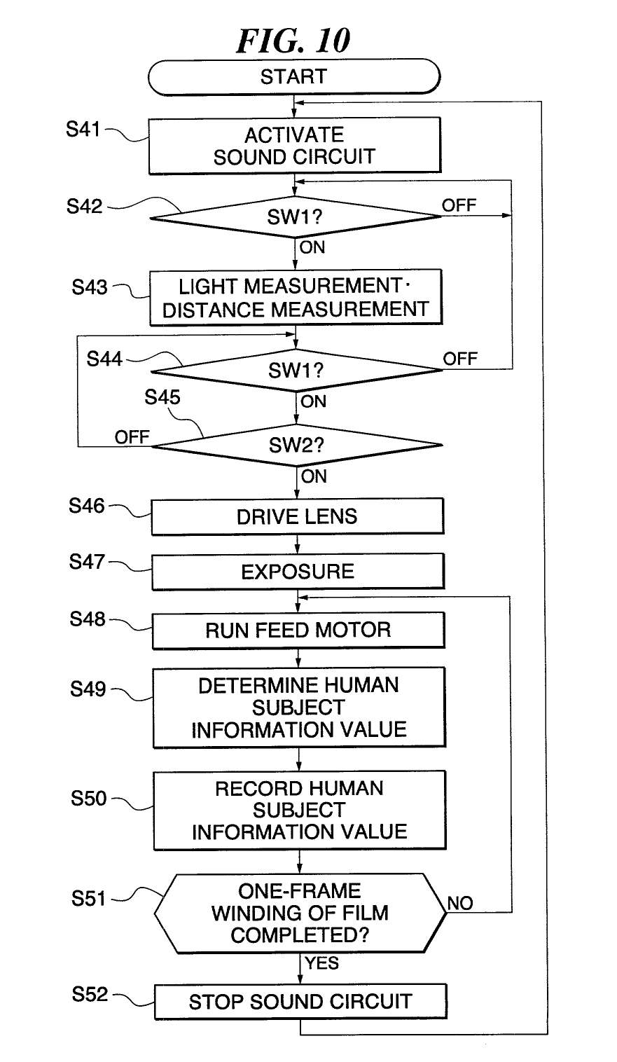

Referring next to a flow chart of FIG. 10, there will be described the operation of the microcomputer 49 according to the present embodiment.

At the start of the operation, the power supply to the camera body is turned on by depression of a camera main switch or the like. The process then proceeds to a step S41.

In the step S41, the sound circuit 62 is activated to collect the ambient sounds in the surroundings of the camera picked up by the microphone 63. The collected sound information is sampled at regular time intervals so as to determine whether specific words registered in the speech recognition circuit section, e.g. words indicating a high possibility of human subject photography are included in the sound information or not. A human subject information value indicating the possibility of human subject photography is determined according to how much human subject information is included in the sound information sampled at regular time intervals. The higher the human subject information value, the higher the possibility that a human subject photograph will be taken.

For example, if “Now, smile”, “Turn here, please”, and “Miss. ∘∘” are registered as specific words, the human subject information value is determined by picking out these specific words from the sounds in the surroundings of the camera. The human subject information value is outputted at regular time intervals, and the microcomputer 49 temporarily records these values.

The above determination should not necessarily be made for the above specific words, but may also be made for other similar words.

If it is recognized in the next step S42 that the switch SW1 has been turned on by depressing half the shutter release button 42, the process proceeds to a step S43. In the step S43, information is inputted from the light measuring circuit 52 and the distance measuring circuit 53 so as to find the subject brightness and the subject distance, and an exposure value is determined according to this information and a known film sensitivity. In the next step S44, the status of the switch SW1 is detected again. If the switch SW1 is OFF, the process returns to the step S42, and if the switch SW1 is ON, the process proceeds to a step S45 to detect the status of the switch SW2. If the switch SW2 is turned on by fully depressing the shutter release button 42, the process proceeds to a step S46. If the switch SW2 is OFF, the process returns to the step S44.

In the step S46, the lens control circuit 57 determines the lens drive amount according to the subject distance information acquired in the step S43, and drives the lens to a focusing position. If the lens has moved to a predetermined position, the process proceeds to a step S47 wherein the shutter control circuit 58 and the strobe control circuit 59 control the opening and closing actions of the shutter and the emission of a strobe light, respectively, according to the exposure value determined in the step S43 to expose a subject image on the film.

After the exposure, the process proceeds to a step S48 wherein a feed motor rotates under the control of the film feeding circuit 54 to start winding the film.

In the step S49, one value is selected from multiple human subject information values that have been recorded at regular time intervals since the sound circuit is activated in the step S41. One human subject information value may be selected arbitrarily. For example, a human subject information value just before the exposure may be selected, and the maximum value in a time zone several sections before the value just before the exposure value may be selected.

The process then proceeds to a step S50. In synchronism with the film winding action, the magnetic head writes the human subject information value as well as other information (e.g. photographic information and information on date and time) in the magnetic information-recording section on the film under the control of the magnetic recording circuit 55. Upon completion of the writing in the magnetic information-recording section on the film, the process proceeds to a step S51.

If it is detected in the step S51 that the film has been wound by one frame, the process proceeds to a step S52 to clear the human subject information value and stop the operation of the sound circuit, to thereby complete the sequence of the operations. If the film has not yet been wound by one frame, the process returns to the step S48.

According to the present embodiment, speech information indicating a high possibility that a human subject will be photographed is recognized from the information on sounds in the surroundings of the camera, and the camera then determines the possibility that a human subject will be photographed (the human subject information value) according to the speech information and records the determination result on the film.

Further, the printing apparatus in FIG. 6 determines the print density on the basis of the human subject information value, and this makes it possible to make a high grade print in which the face of a human subject has the optimum density.

In the above described embodiments, the information indicative of human subject photography or the value representing the possibility of human subject photography is magnetically recorded on the film having the magnetic recording layer. It is needless to say, however, that the same effects can be achieved by using a camera that is used with a film having no magnetic recording layer and records the information in an external memory. In this case, the printing operation is carried out based upon the information stored in the external memory and the film having no magnetic recording layer at a laboratory.

Further, the same effects can be achieved by a digital camera which records the information as data corresponding to image information or records the information in an external memory such as a compact flash card.

According to the camera of the present invention, there is no necessity of extracting a human subject by image analysis requiring a vast amount of operations, and thus, a high grade print with the optimum density for a human subject can be produced according to the information indicative of human subject photography or the value representing the possibility of human subject photography, the information or the value which is recorded in a manner corresponding to the captured image.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A camera comprising:
an input device for inputting an instruction for a camera user to take a human subject photograph; and
a recording device responsive to inputting of the instruction for the camera user to take the human subject photograph by said input device, for recording information indicative of human subject photography in a manner corresponding to a captured image.

2. A camera according to claim 1, wherein said recording device magnetically records the information on a film.

3. A camera according to claim 1, wherein said recording device records the information in an external memory.

4. A camera according to claim 1, wherein said input device comprises an operation switch.

5. A camera according to claim 1, wherein said input device comprises a speech recognition device.

6. A camera according to claim 1, further comprising: a calculating device for calculating a subject image magnification; and
wherein if the subject image magnification calculated by said calculating device lies in a predetermined range, said recording device records the information indicative of human subject photography in a manner corresponding to the captured image.

7. A camera according to claim 6, wherein the predetermined range of the subject image magnification is substantially between 1/150 and 1/25 in terms of 135 film magnification if a human subject is photographed.

8. A camera comprising:
a determination device for determining a value representing a possibility of human subject photography according to at least one setting condition which is likely to be used for human subject photography, among a plurality of setting conditions relating to a photographing operation; and
a recording device for recording the value representing the possibility of human subject photography determined by said determination device, in a manner corresponding to a captured image.

9. A camera according to claim 8, wherein said recording device magnetically records the information on a film.

10. A camera according to claim 8, wherein said recording device records the information in an external memory.

11. A camera according to claim 8, wherein said at least one setting condition likely to be used for the human subject photography includes at least one of a red-eye alleviation mode, a portrait mode, a number-of-prints setting, a self-timer mode, and a remote control mode.

12. A camera according to claim 8, further comprising:
a calculating device for calculating a subject image magnification; and
wherein if the subject image magnification calculated by said calculating device lies in a predetermined range, said recording device records the information indicative of human subject photography in a manner corresponding to the captured image.

13. A camera according to claim 8, wherein:
if a human subject is photographed, the predetermined range of the subject image magnification is substantially between 1/150 and 1/25 in terms of 135 film magnification.

14. A camera comprising:
a determination device for determining a value representing a possibility of human subject photography according to a plurality of setting conditions which are likely to be used for human subject photography among a plurality of setting conditions relating to a photographing operation;
a recording device for recording the value representing the possibility of human subject photography, determined by said determination device, in a manner corresponding to a captured image; and
wherein said determination device determines the value representing the possibility of human subject photography, by accumulating values representing possibilities of human subject photography corresponding respectively to the plurality of setting conditions which are likely to be used for human subject photography.

15. A camera according to claim 14, further comprising:
a calculating device for calculating a subject image magnification; and
wherein if the subject image magnification calculated by said calculating device lies in a predetermined range, said recording device records the information indicative of human subject photography in a manner corresponding to the captured image.

16. A camera according to claim 14, wherein the predetermined range of the subject image magnification is substantially between 1/150 and 1/25 in terms of 135 film magnification if a human subject is photographed.

17. A camera comprising:
a determination device for determining a value representing a possibility of human subject photography by recognizing at least one speech or at least one speech similar thereto; and
a recording device for recording the value representing the possibility of human subject photography determined by said determination device, in a manner corresponding to a captured image.

18. A camera according to claim 17, wherein said recording device magnetically records the information on a film.

19. A camera according to claim 17, wherein said recording device records the information in an external memory.

20. A camera according to claim 17, further comprising:
a calculating device that calculates a subject image magnification; and
wherein if the subject image magnification calculated by said calculating device lies in a predetermined range, said recording device records the information indicative of human subject photography in a manner corresponding to the captured image.

21. A camera according to claim 20, wherein the predetermined range of the subject image magnification is substantially between 1/150 and 1/25 in terms of 135 film magnification if a human subject is photographed.

22. A printing apparatus that adjusts a print density according to the information indicative of human subject photography or the value representing the possibility of human subject photography, the information or the value being magnetically recorded on the film by a camera according to any of claims 1 to 21.
